(19) United States
(12) Patent Application Publication
(10) Pub. No.: US 2014/0056364 A1
(43) Pub. Date: Feb. 27, 2014

(54) INFORMATION PROCESSING APPARATUS, INFORMATION PROCESSING METHOD, AND PROGRAM

(71) Applicant: Sony Corporation, Tokyo (JP)

(72) Inventors: Kensaku Wakuda, Kanagawa (JP); Hiroaki Takahashi, Kanagawa (JP)

(73) Assignee: Sony Corporation, Tokyo (JP)

(21) Appl. No.: 13/970,701

(22) Filed: Aug. 20, 2013

(30) Foreign Application Priority Data
Aug. 27, 2012 (JP) 2012-186530

(51) Int. Cl. H04N 7/26

(52) U.S. Cl. CPC H04N 19/0086
USPC 375/240.24

(57) ABSTRACT

There is provided an information processing apparatus including an encoding section and an output section. The encoding section is configured to be able to encode a plurality of pictures of video data on a block basis, the block being a part of each of the pictures. The output section is configured to be able to distribute the encoded blocks to have two of the blocks outputted separately onto two of a plurality of media, the two of the blocks having the same position in two consecutive pictures of the pictures.

### BACKGROUND

The present technology relates to an information processing apparatus capable of processing moving image data for each of a plurality of encoding blocks, and an information processing method and a program in the information processing apparatus.

Recently, a demand has been growing for transmission of multimedia data with a low delay via the Internet and any other transmission paths. As an example, the delay of several frame intervals or less is desirable for transmission of moving images in the application of a so-called remote-controlled surgery, e.g., two medical facilities away from each other are connected over the Internet and others, and moving images of a surgery being performed in one place (remote-controlled operating room) are transmitted to the other place, and in the other place, the video is used as a basis to remotely control surgical instruments in use.

In order to meet the demand, Japanese Patent Application Laid-open No. 2007-311924 (hereinafter, referred to as Patent document 1) describes a technique of compression encoding by Wavelet transform with which a compression/encoding block for use is several lines of each picture in moving images. With this technique, there is no need to wait for the data in the pictures to be entirely input to start compression encoding. Moreover, for an apparatus on the reception end to decode compressed data transmitted over a network, the apparatus on the reception end may start the decoding process before receiving the entire data in the pictures. Accordingly, if a network propagation delay is sufficiently short, the moving images may be transmitted in real time with a delay of a frame interval or shorter.

The concern here is that, at the site of video production, a demand is gradually growing for storage of video data on storage media (disks). The video data is the one compressed and encoded by a low-delay codec described in Patent Document 1. With the low-delay codec described in Patent Document 1, however, the compressed-and-encoded video data is huge in amount because no interframe predictive coding is performed.

For use as an auxiliary storage capable of real-time storage of the huge amount of data, there is RAID (Redundant Arrays of Independent Disks)-0 and others described in Non-patent Document 1 (Patterson et al., “A case for Redundant Arrays of Inexpensive Disks (RAID)”, Proceedings of the 1988 ACM SIGMOD international conference on Management of data, pp. 109-116). For a real-time storage process temporarily performed on data, the use of a high-speed Flash SSD (Solid State Drive) may be a possibility. However, this drive uses a flash memory being a semiconductor memory, thereby having an upper limit for rewriting, and being not suitable for a long-time use. These are both a type of Striping System aiming to improve the sustained data transfer speed of disks.

Such a Striping System, however, has a problem associated with fault tolerance. The Striping System in the simple structure of including a plurality of disks like a RAID-0 system has a disadvantage of not allowing reading of the entire data if a single disk becomes faulty.

In consideration thereof, the Striping System utilizing the RAID technology is designed to improve the fault tolerance with a RAID-1+0 (RAID-0+1) system, a RAID-5 system, a RAID-6 system, and others. In order to be redundant, the RAID-1+0 (RAID-0+1) system uses two or more disks for striping, and for mirroring, uses at least twice as many as the disks for striping. With the Raid-5 and RAID-6 systems, error correction coding data (parity) is generated at the time of data writing and is distributed to a plurality of disks for storage.

Data for storage is divided into data of a fixed size called “Chunk”, and the consecutive Chunks are distributed and placed in disks in a RAID system. With this distributed placement, the consecutive data is read/written from/to a plurality of disks all at once. Therefore, the RAID-5 system, the RAID-6 system, and others may perform data reading and writing of data in proportion to the number of disks in the RAID system per unit time. This accordingly improves the data access performance.

For reference, see Japanese Patent Application Laid-open No. 2008-288833.

### SUMMARY

However, there still is a problem even with the redundant configuration of the RAID-5 or RAID-6 system. That is, if a failure occurs in the disks equal in number to or larger in number than those allowed for the configuration, the entire video data becomes not available for reproduction. For example, with the RAID-5 system, the number of disks allowed for simultaneous failure is one, and with the RAID-6 system, the number thereof is two. If a failure occurs at the same time in the disks exceeding the number allowed for the respective RAID systems, i.e., two and three, no data reproduction is available using the error correction coding data. The possibility is generally considered extremely low for the disks in the RAID system to be failed all at the same time. However, Non-patent Document 2 (Yoshimitsu Nagai, “Parameter estimation in dependent competing risks model with environmental stress using masked data”, transaction of the Institute of Electronics, Information and Communication Engineers, A, Fundamentals of Electronics, Communications and Computer Sciences J85-A(9), pp. 1014-1021, Sep. 1, 2002) assumes that simultaneous disk failure is highly possible because the disks are actually under environmental stress equally in the same conditions.

For these reasons as above, it is not recommended for storage of video data with the redundant configuration using the striping system in related art.

It is thus desirable to provide an information processing apparatus, an information processing method, and a program with which, even if a failure occurs in storage media or transmission media, performing a concealment process may increase a probability of video decompression on the faulty media.

According to an embodiment of the present technology, there is provided an information processing apparatus including an encoding section and an output section. The encoding section is configured to be able to encode a plurality of pictures of video data on a block basis, the block being a part of each of the pictures. The output section is configured to be able to distribute the encoded blocks to have two of the blocks outputted separately onto two of a plurality of media, the two of the blocks having the same position in two consecutive pictures of the pictures.

With the information processing apparatus, by outputting two blocks having the same position in two consecutive pictures separately onto two different media, even if a failure occurs in one of the media, performing a concealment process may increase a probability of video data decompression on the faulty media.

Herein, the picture is a term for a piece of screen, and means a piece of frame when the video data is subjected to encoding/decoding as the frame structure. When the video data is subjected to encoding/decoding as the field structure, the picture means a piece of field. The output section may output the blocks to the inside of the information processing apparatus or to the outside thereof.

The output section may be able to output the blocks to have two of the blocks outputted separately onto two of the media, the two of the blocks being adjacent to each other in one of the pictures.

Accordingly, even if any of the media becomes faulty, the information processing apparatus may minimize the area of the blocks to be lost in the picture.

The information processing apparatus may further include a reproduction section. The reproduction section is configured to be able to reproduce, when at least one of the media becomes faulty, the video data by concealing the block at a first position in a first picture by the block at the first position in a second picture in the pictures, the first picture being found on the faulty medium, the second picture being closest in time to the first picture.

As described above, the information processing apparatus conceals the lost block by another block in a picture having the highest correlation with the picture including the lost block, thereby minimizing any possible degradation of video to be caused by the concealment process.

The encoding section may be able to generate an error correction code for each of the blocks including the two blocks adjacent to each other. In this case, the output section may be able to output the blocks not to have the error correction code outputted onto any same one of the media as the block based on which the error correction code is generated. Also in this case, when at least one of the media becomes faulty, and when the block at the first position in the first picture is failed to be decoded by the error correction code, the reproduction section may be able to conceal the block at the first position in the first picture by the block at the first position in the second picture.

Accordingly, when only one of the media is found faulty, for example, the information processing apparatus may fully decode the original block using the error correction code (parity).

The encoding section may be able to encode at least one line in each of the pictures as the block.

Because the video data is generally input on a line basis, with the information processing apparatus in the above-mentioned configuration, a processing delay may be reduced by encoding of video data on a line basis compared to the case of data processing on a picture basis. When a block is configured by a plurality of lines, these lines may be adjacent to one another in the vertical direction in a picture or may be away from one another therein.

The encoding section may be able to encode at least one pixel region in a predetermined shape as the block, the pixel region being a part of each of the pictures.

Herein, the predetermined shape is arbitrary, including square, rectangle, circle, ellipse, and others. When a block is configured by a plurality of pixel regions, the pixel regions may be adjacent to one another in a picture or may be away from one another therein. In the pixel region, the number of pixels and the shape thereof may be varied every time the encoding process is performed.

The media may include a plurality of storage media. In this case, the output section may output the encoded blocks to be distributed to the storage media for storage.

The media may include a plurality of transmission media. In this case, the output section may be able to output the encoded blocks onto the transmission media to be received by a reception apparatus by being distributed and transmitted onto the transmission media. Also in this case, the reception apparatus may be able to reproduce, when at least one of the transmission media becomes faulty, the video data by concealing the block at a first position in a first picture by the block at the first position in a second picture in the pictures, the first picture being transmitted onto the faulty medium, the second picture being transmitted to and received by the remaining transmission medium, the second picture being closest in time to the first picture.

Accordingly, by transmitting the encoded blocks separately onto a plurality of transmission media, even if any of the transmission media becomes faulty and even if data is lost thereby, the information processing apparatus may conceal the lost data using blocks correctly received on the reception apparatus end via the remaining not-faulty transmission media.

Herein, the transmission media mean any type of a network medium including the Internet, LAN (Local Area Network), and others, and may be a cable medium or a wireless medium.

According to another embodiment of the present technology, there is provided an information processing method including: encoding a plurality of pictures of video data on a block basis, the block being a part of each of the pictures; and distributing the encoded blocks to have two of the blocks outputted separately onto two of a plurality of media, the two of the blocks having the same position in two consecutive pictures of the pictures.

According to still another embodiment of the present technology, there is provided a program causing an information processing apparatus to execute: encoding a plurality of pictures of video data on a block basis, the block being a part of each of the pictures; and distributing the encoded blocks to have two of the blocks outputted separately onto two of a plurality of media, the two of the blocks having the same position in two consecutive pictures of the pictures.

As described above, according to the present technology, if a failure occurs in storage media or transmission media, performing a concealment process may increase a probability of video decompression on the faulty media.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram showing the hardware configuration of a recording/reproduction apparatus in a first embodiment of the present technology;

FIG. 2 is a block diagram showing the software module configuration of the recording/reproduction apparatus of FIG. 1;

FIG. 3 is a diagram showing exemplary encoding blocks generated by an encoding section of FIG. 2, and exemplary parity blocks generated by an information accumulation section of FIG. 2;

FIG. 4 is a flowchart showing the flow of a process of accumulating the encoding blocks by the information accumulation section of FIG. 2;

FIG. 5 is a diagram showing an exemplary distribution of the encoding blocks and the parity blocks accumulated in an auxiliary storage array by the information accumulation section of FIG. 2;

FIG. 6 is a flowchart showing the flow of a process of acquiring the encoding blocks by an information acquisition section of FIG. 2;

FIG. 7 is a diagram schematically showing how a piece of picture is accumulated as the encoding blocks by the information accumulation section of FIG. 2;

FIG. 8 is a diagram schematically showing how a picture subsequent to the picture of FIG. 7 is accumulated as the encoding blocks by the information accumulation section of FIG. 2;

FIG. 9 is a diagram schematically showing how a picture becomes partially not available for reading when a failure occurs in one auxiliary storage in the auxiliary storage array of FIG. 2;

FIG. 10 is a diagram schematically showing how a concealment process is performed by the information acquisition section in the case of FIG. 9;

FIG. 11 is a diagram showing exemplary encoding blocks generated in a second embodiment of the present technology;

FIG. 12 is a diagram showing exemplary parity blocks generated in the second embodiment of the present technology;

FIG. 13 is a flowchart showing the flow of a process of accumulating the encoding blocks and the parity blocks in the second embodiment;

FIG. 14 is a diagram showing an exemplary distribution of the encoding blocks accumulated in an auxiliary storage array in the second embodiment; and

FIG. 15 is a diagram showing a network configuration and transmission routes for the encoding blocks in a third embodiment of the present technology.

### DETAILED DESCRIPTION OF EMBODIMENTS

Hereinafter, embodiments of the present technology will be described with reference to the drawings.

### First Embodiment

Described first is a first embodiment of the present technology. In this embodiment, described is an exemplary recording/reproduction apparatus to which the present technology is applied.

### (Hardware Configuration of Recording/Reproduction Apparatus)

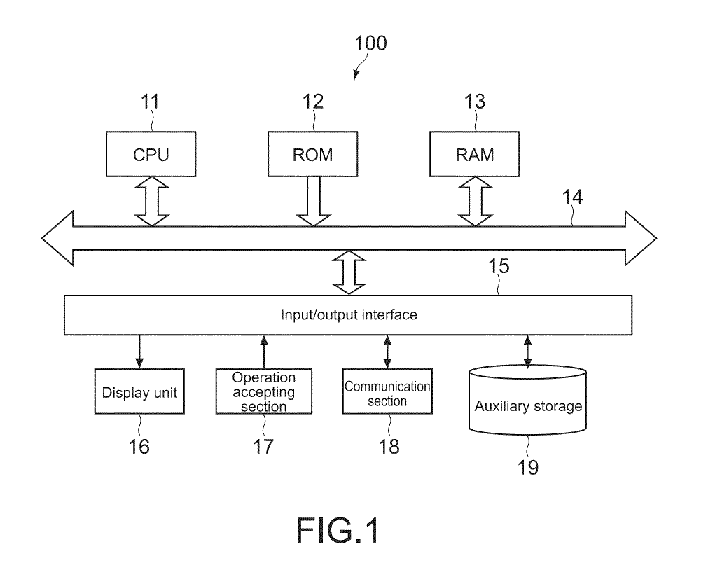

FIG. 1 is a diagram showing the hardware configuration of a recording/reproduction apparatus in the first embodiment.

As shown in FIG. 1, a recording/reproduction apparatus 100 is configured to include a CPU (Central Processing Unit) 11, a ROM (Read Only Memory) 12, a RAM (Random Access Memory) 13, an input/output interface 15, and a bus 14 that connects these components.

If necessary, the CPU 11 accesses the RAM 13 being a main storage and others as appropriate, and controls over the entire blocks in the recording/reproduction apparatus 100 while performing various types of computing processes. The ROM 12 is a nonvolatile memory retaining an Os (Operating System) for the CPU 11 to run, and firmware including programs, various parameters, and others. The RAM 13 is used as a work area for the CPU 11, for example, and temporarily stores the OS, various applications during execution, and various data in the process.

The input/output interface 15 is connected with components, i.e., a display unit 16, an operation accepting section 17, a communication section 18, an auxiliary storage 19, and others.

The display unit 16 uses an LCD (Liquid Crystal Display), OELD (Organic ElectroLuminescence Display), CRT (Cathode Ray Tube), and others. The display unit 16 displays video data, which is stored on and read from the auxiliary storage 19, for example. The display unit 16 may be provided in the recording/reproduction apparatus 100, may be connected thereto via a cable and others, or may be physically away therefrom and connected therewith over a network.

The operation accepting section 17 is an input unit including a pointing device such as mouse, a keyboard, a touchscreen, and others. When the operation accepting section 17 is a touchscreen, the touchscreen may be in one piece with the display unit 16. Alternatively, the operation accepting section 17 may be a light reception section that receives a control signal, i.e., infrared rays, from a remote control.

The auxiliary storage 19 is a nonvolatile memory including an HDD (Hard Disk Drive), a flash memory (SSD; Solid State Drive), and others. This auxiliary storage 19 stores the OS described above, programs including software modules and applications that will be described later, and various data including video data, for example. The programs may be provided to the recording/reproduction apparatus 100 over the network or may be installed thereto via a recording medium readable thereby.

In this embodiment, two or more of the auxiliary storage 19 are provided to be ready for distributed storage of video data on an encoding block basis. In the description below, these auxiliary storages 19 are sometimes collectively referred to as auxiliary storage array. The OS and the programs described above may not be stored on the auxiliary storage array but in another storage. That is, the auxiliary storage array may be provided only for distributed storage of the video data on an encoding block basis. In this embodiment, the auxiliary storage 19 is sometimes referred to as “disk”.

The communication section 18 is in charge of a communication process with external equipment. This communication may be cable or wireless communication. When the communication section 18 performs cable communication, the communication section 18 is an NIC (Network Interface Card) and others connectable to an Ethernet (trademark) cable, for example. When the communication section 18 performs wireless communication, the communication section 18 is a wireless LAN module, for example.

### (Module Configuration of Recording/Reproduction Apparatus)

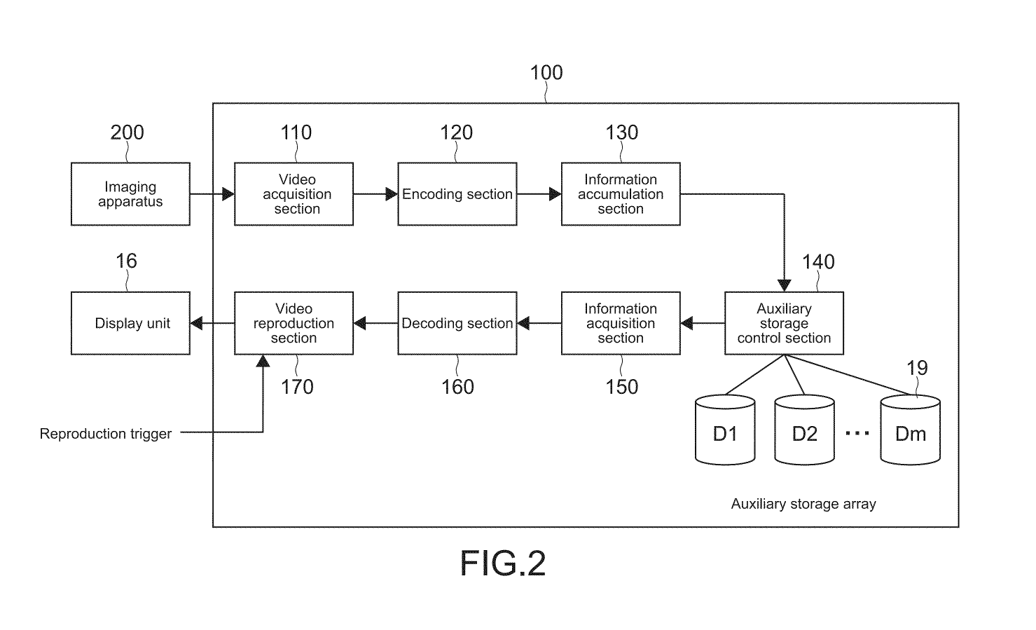

FIG. 2 is a function block diagram showing the configuration of a software module of the recording/reproduction apparatus 100 described above. The software module in FIG. 2 is for video data to be reproduced from the beginning by a user's trigger for reproduction, and to be output to the display unit 16. This video data is the one imaged by an imaging apparatus 200, and sequentially stored on the auxiliary storage 19 in the recording/reproduction apparatus 100. In practical use, the software module of FIG. 2 is not restrictive, and the recording/reproduction apparatus 100 may include another type of software module appropriate for the capabilities of its own.

As shown in FIG. 2, the recording/reproduction apparatus 100 includes software modules of a video acquisition section 110, an encoding section 120, an information accumulation section 130, an auxiliary storage control section 140, an information acquisition section 150, a decoding section 160, and a video reproduction section 170.

The video acquisition section 110 acquires the video data imaged by the imaging apparatus 200 via a predetermined interface, and passes the video data to the encoding section 120 after converting the data into the form to be available for processing by the encoding section 120. The imaging apparatus 200 is a video camera having video imaging capabilities, for example.

The encoding section 120 compresses and encodes pictures of the video data acquired by the video acquisition section 110 in a predetermined mode, thereby generating encoded data, i.e., streams. At this time, the encoding section 120 generates encoding blocks by encoding these pictures for every predetermined encoding unit. This process will be described in detail later. The generated encoded streams are passed to the information accumulation section 130.

The information accumulation section 130 outputs the encoded data generated by the encoding section 120 to the auxiliary storage control section 140 together with a write command. This is for distributed storage of the encoded data in a predetermined order onto a plurality of auxiliary storages 19 configuring the auxiliary storage array. This process will be also described in detail later.

The auxiliary storage control section 140 writes the encoded data to the auxiliary storages 19 in accordance with the write command from the information accumulation section 130. The auxiliary storage control section 140 reads the encoded data stored on the auxiliary storages 19 in accordance with a read command from the information acquisition section 150. The read data is passed to the information acquisition section 150.

The information acquisition section 150 acquires (reads) the encoded data from the auxiliary storage array via the auxiliary storage control section 140 in accordance with the user's trigger for reproduction, and then passes the acquired encoded data to the decoding section 160. The acquisition of the encoded data is performed in a predetermined order on the encoding block basis. At this time, the information acquisition section 150 also performs an error correction process and a concealment process that will be described in detail later. The trigger for reproduction includes a user's physical operation of depressing a button (an operation of a remote control is also included), and a reproduction request over a network, for example.

The decoding section 160 decodes the encoded data provided by the information acquisition section 150 in a predetermined mode, and then passes the resulting data to the video reproduction section 170.

The video reproduction section 170 performs a synchronous process, a data conversion process, and others on the encoded data already subjected to decoding by the decoding section 160. This is to display the encoded data appropriately on the display unit 16. The resulting data is output to the display unit 16.

### (Operation of Recording/Reproduction Apparatus)

Described next is the operation of the recording/reproduction apparatus 100 configured as described above. In this embodiment, for the operation of the recording/reproduction apparatus 100, the CPU 11 cooperates together with the above-described software modules that are under the control thereof for execution.

### (Overview of Operation of Recording/Reproduction Apparatus)

Described first is the overview of the operation of the recording/reproduction apparatus 100.

As described above, the video data imaged by the imaging apparatus 200 is input to the video acquisition section 110, and then is converted in the form to be available for the encoding section 120 to handle. When an input signal from the imaging apparatus 200 is an analog video signal, for example, the video acquisition section 110 performs A/D (Analog/Digital conversion) on the video data, and the video data being the conversion result is passed to the encoding section 120.

Thereafter, the encoding section 120 compresses and encodes the converted video data in a predetermined mode, e.g., in the mode described in Patent Document 1 above, to have encoded data, i.e., encoded streams. The encoding section 120 also generates a plurality of encoding blocks, each of which is a plurality of lines of each picture of the video data. The resulting encoding blocks are passed to the information accumulation section 130.

Herein, the picture is a term for a piece of screen, and means a piece of frame when the video data is subjected to encoding/decoding as the frame structure. When the video data is subjected to encoding/decoding as the field structure, the picture means a piece of field.

Next, the information accumulation section 130 generates an error correction coding block (parity block) based on the encoding blocks.

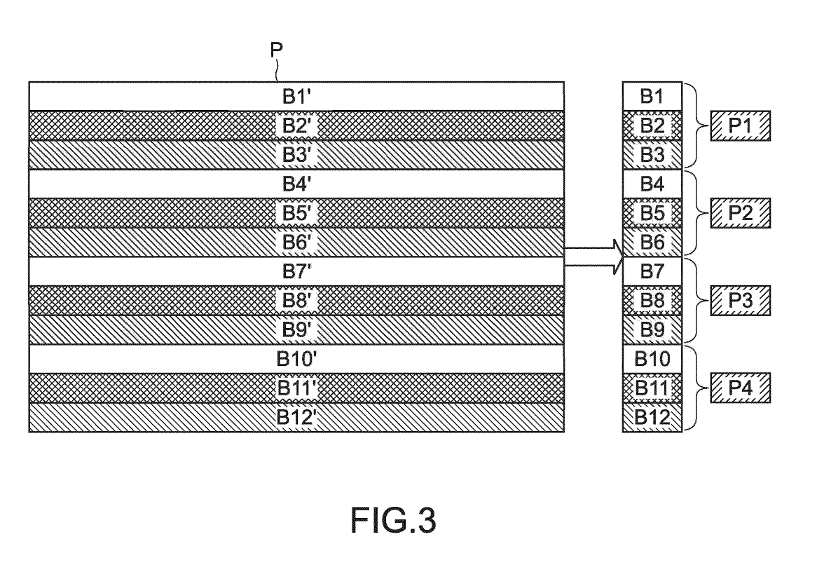

FIG. 3 is a diagram showing exemplary encoding blocks generated by the encoding section 120, and exemplary parity blocks generated by the information accumulation section 130.

As shown in FIG. 3, the encoding section 120 divides a picture into a plurality of blocks (B1′ to B12′) based on a unit of a plurality of consecutive lines, e.g., several lines, or several tens of lines. In the example of FIG. 3, the picture is divided into 12 blocks, but the number of blocks is not restrictive. The encoding section 120 encodes each of the blocks, thereby generating encoding blocks (B1 to B12).

At this time, the encoding section 120 generates the encoding blocks in a downward direction starting from the block including the first line of the picture. For each of the encoding blocks thus generated, the encoding section 120 writes a block number (No) to the header thereof in the ascending order. In the example of FIG. 3, the block Nos in the picture are 001 to 012. The header is written also with a picture No that indicates the position of the picture in the video data. With the picture No and the block No, the encoding blocks may be identified by position in a video content.

The information accumulation section 130 generates a parity block on the basis of the predetermined number of encoding blocks. As an example, a parity block is generated on the basis of the number of blocks, the number of which is one less than the number of disks. In this embodiment, the number of the disks is four, for example, and the three disks are for storage of the encoding blocks, and the remaining one disk is for storage of the parity blocks. Accordingly, the information accumulation section 130 generates a parity block on the basis of the three encoding blocks. In the example of FIG. 3, a parity block P1 is generated based on the encoding blocks B1 to B3, a parity block P2 is generated based on the encoding blocks B4 to B6, a parity block P3 is generated based on the encoding blocks B7 to B9, and a parity block P4 is generated based on the encoding blocks B10 to B12.

Used for generating the parity blocks is a simple bit-wise XOR (eXclusive OR), for example.

Next, the information accumulation section 130 determines in which of the auxiliary storages the encoding blocks and the parity blocks are to be stored, and in what order. That is, the information accumulation section 130 makes a selection of the auxiliary storages 19 from the auxiliary storage array for the use to store the encoding blocks and the parity blocks. The information accumulation section 130 then passes the encoding blocks and the parity blocks to the auxiliary storage control section 140 on the block basis together with a write command including information about the selected auxiliary storages 19.

Next, based on the write command from the information accumulation section 130, the auxiliary storage control section 140 writes the encoding blocks and the parity blocks onto a plurality of auxiliary storages 19 configuring the auxiliary storage array.

In response to a trigger for reproduction of the video data, the information acquisition section 150 searches the auxiliary storage array for the auxiliary storage 19 storing the encoding blocks to be read. The information acquisition section 150 then reads the found encoding blocks in a predetermined order via the auxiliary storage control section 140. The read encoding blocks are passed to the decoding section 160.

At this time, when any of the auxiliary storages 19 is faulty, the information acquisition section 150 performs either the error correction process using the parity blocks or the concealment process depending on the degree of the fault.

The decoding section 160 then decodes the encoding blocks in a predetermined mode corresponding to the encoding section 120, and then passes the resulting encoding blocks to the video reproduction section 170.

The video reproduction section 170 performs a synchronous process, a conversion process, and others on the encoding blocks already subjected to decoding as above. This is to display the encoding blocks on the display unit 16, and the processed data is output to the display unit 16.

### (Operation of Information Accumulation Section)

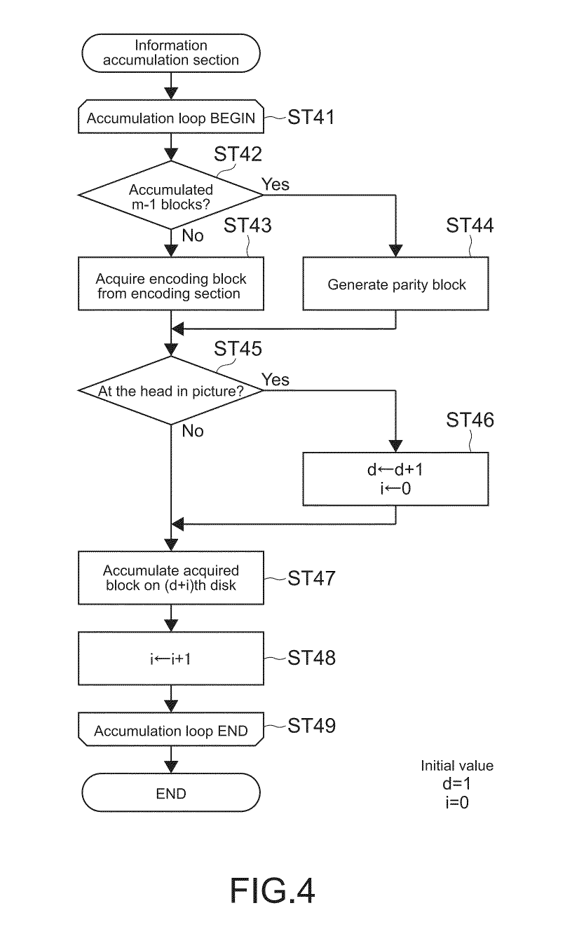

Described next is the detailed operation of the information accumulation section 130. FIG. 4 is a flowchart showing the flow of a process of accumulating (writing) the encoding blocks by the information accumulation section 130. In FIG. 4, the number of disks configuring the auxiliary storage array is m, for example.

As shown in FIG. 4, when receiving the encoding blocks from the encoding section 120, the information accumulation section 130 starts a loop process of accumulating the encoding blocks (steps 41 to 49).

In this loop process, as to the number of the encoding blocks accumulated (passed to the auxiliary storage control section 140) as above, the information accumulation section 130 determines whether or not the number reaches m−1 (step 42).

When determining that the number of the accumulated encoding blocks is not yet m−1 (No), the information accumulation section 130 acquires another encoding block from the encoding section 120 (step 43).

On the other hand, when determining that the number of the accumulated encoding blocks is m−1 (Yes), the information accumulation section 130 generates a parity block using the (m−1) pieces of blocks (step 44).

Next, as to the acquired encoding block, the information accumulation section 130 refers to the block No in the header thereof to determine whether or not the encoding block is at the head in the picture (step 45).

When determining that the encoding block is at the head in the picture (Yes), the information accumulation section 130 increments the value of a counter d for use to make a disk selection, and initializes the value of a counter i also for use to make a disk selection (step 46). Herein, the initial value of the counter d is 1, and the initial value of the counter i is 0.

When determining that the encoding block is not at the head in the picture (No), and when the process of step 46 is done, the information accumulation section 130 issues a write command for the auxiliary storage control section 140 to accumulate the encoding block acquired as above on the (d+i)th disk (step 47).

Next, the information accumulation section 130 increments the value of the counter i (step 48), and the procedure returns to step 42 and repeats the process of step 42 and subsequent processes.

That is, the information accumulation section 130 generates a parity block on the basis of the acquired (m−1) encoding blocks, and stores the m blocks in order from the dth disk to the (d+m−1)th disk. After storing all of the blocks in one picture onto the disks, the information accumulation section 130 stores in order the blocks in the next picture starting from the (d+1)th disk.

As described above, every time the information accumulation section 130 receives the encoding block from the encoding section 120, the procedure repeats the above-mentioned processes of steps 42 to 48, and the encoding blocks and the parity blocks are distributed to and stored on a plurality of disks via the auxiliary storage control section 140.

Alternatively, the information accumulation section 130 may perform the process of generating the parity blocks at the same time with the process of accumulating the blocks in an attempt to increase the processing speed.

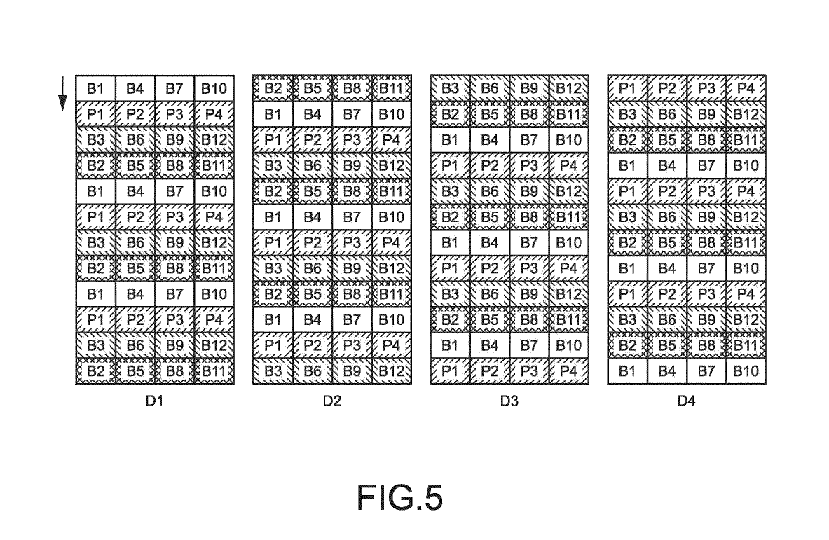

FIG. 5 is a diagram showing an exemplary distribution of blocks stored on four disks D1 to D4 by the processes described above.

As shown in FIG. 5, as to the first picture, three encoding blocks and a parity block are stored in order of D1, D2, D3, and D4 based on the block Nos thereof. As to the next picture, the blocks are stored in order of D2, D3, D4, and D1 based on the block Nos thereof.

With the distributed storage process as described above, any two encoding blocks having the same position in two consecutive pictures are stored separately on different disks. As an example, an encoding block B1 in the first picture is stored on the disk D1, and another encoding block B1 having the same position in the second picture is stored on the disk D2.

With the distributed storage as above, when any of the disks becomes faulty, an encoding block in a picture stored on the faulty disk may be concealed by another encoding block having the same position in the previous and next pictures.

FIG. 5 shows that any two encoding blocks adjacent to each other in a picture are stored separately on different disks. As an example, as to encoding blocks B2 and B3 adjacent to each other in the first picture, the encoding block B2 is stored on the disk D2, and the encoding block B3 is stored on the disk D3.

Accordingly, when any of the disks becomes faulty, the distributed storage as above may minimize the area of the encoding blocks to be lost and failed to be read (and resulting in the concealment process or the error correction process) in a picture.

### (Operation of Information Acquisition Section)

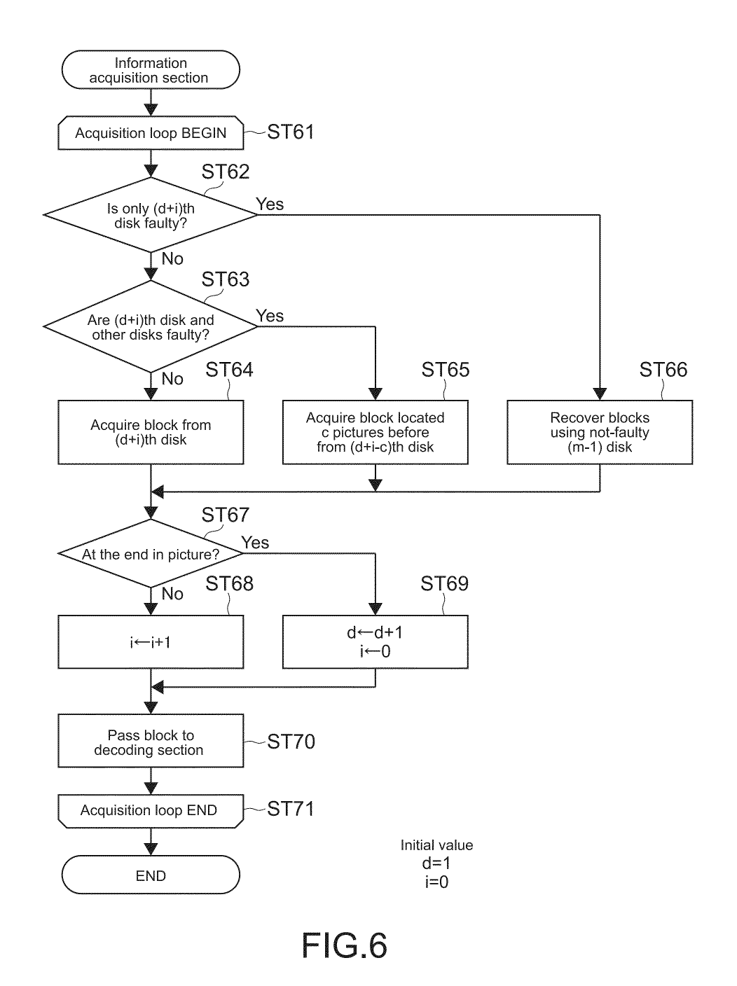

Described next is the detailed operation of the information acquisition section 150. FIG. 6 is a flowchart showing the flow of a process of acquiring (reading) the encoding blocks by the information acquisition section 150.

As shown in FIG. 6, in response to the above-mentioned trigger for reproduction, the information acquisition section 150 starts a loop process of acquiring the encoding blocks from the auxiliary storage array (step 61 to 71).

In the loop process, prior to acquiring the encoding blocks from the (d+i)th disk, the information acquisition section 150 determines whether or not only the (d+i)th disk is faulty (step 62). The initial value of the counter d is 1, and the initial value of the counter i is 0. Whether or not the disk is faulty depends on whether or not the encoding blocks thereon are available for reading.

When determining that only the (d+i)th disk is faulty (Yes), the information acquisition section 150 recovers the encoding blocks on the (d+i)th disk using the encoding blocks and the parity blocks in the remaining not-faulty (m−1) disks (step 66).

When determining that the (d+i)th disk and other disks are faulty (Yes in step 63), from the (d+i−c)th disk, the information acquisition section 150 acquires an encoding block having the same position as the reading-not-available encoding block in the (d+i)th disk (step 65). The acquired encoding block is the one in a picture located c pictures previous to the picture including the reading-not-available encoding block stored on the (d+i)th disk.

Herein, c is an integer of 1 or larger, and the smaller the better. When the (d+i−1)th disk is found not faulty, for example, from the disk, the information acquisition section 150 acquires an encoding block in a picture previous to the picture not available for reading any more. When the (d+i−1)th disk is found faulty, from the (d+i−2)th disk, the information acquisition section 150 acquires an encoding block in the two pictures before. That is, the information acquisition section 150 conceals the reading-not-available encoding block by another encoding block having the same position in the previous picture closest in time to the picture including the reading-not-available encoding block.

On the other hand, when determining that none of the disks is faulty (No in step 63), the information acquisition section 150 acquires any of the encoding blocks from the (d+i)th disk (step 64).

Thereafter, the information acquisition section 150 determines whether or not the acquired encoding block is at the tail end in a picture (step 67).

When determining that the acquired encoding block is not at the tail end in the picture (No), the information acquisition section 150 increments the value of the counter i (step 68), and passes the acquired encoding block to the decoding section 160 (step 70). Thereafter, the encoding block acquisition process is repeated for the same picture.

On the other hand, when determining that the acquired encoding block is at the tail end in the picture (Yes), the information acquisition section 150 increments the value of the counter d, and initializes the value of the counter i (step 69). Thereafter, in order from the (d+i+1)th disk, the encoding block acquisition process is performed on the next picture starting from the head thereof.

As described above, in response to a video-data reproduction command, starting from a picture at the predetermined position, i.e., normally a picture at the head, the information acquisition section 150 acquires the encoding blocks via the auxiliary storage control section 140, and passes the acquired encoding blocks to the decoding section 160. When any one of the disks becomes faulty, the information acquisition section 150 uses the parity blocks to recover any reading-not-available encoding blocks. When any two or more of the disks become faulty, the information acquisition section 150 conceals any reading-not-available encoding blocks using other encoding blocks having the same position in a picture previous to the picture including the reading-not-available encoding blocks.

Herein, the information acquisition section 150 may perform the processes all at the same time in an attempt to increase the processing speed, i.e., the encoding block acquisition process (step 64), the encoding block recovery process (step 66), and the concealment process (step 65).

FIG. 6 shows the example that a disk is entirely faulty, but also when a disk becomes partially faulty and when encoding blocks are partially not available for reading, the processes similar to the above are performed.

### (Exemplary Concealment Process)

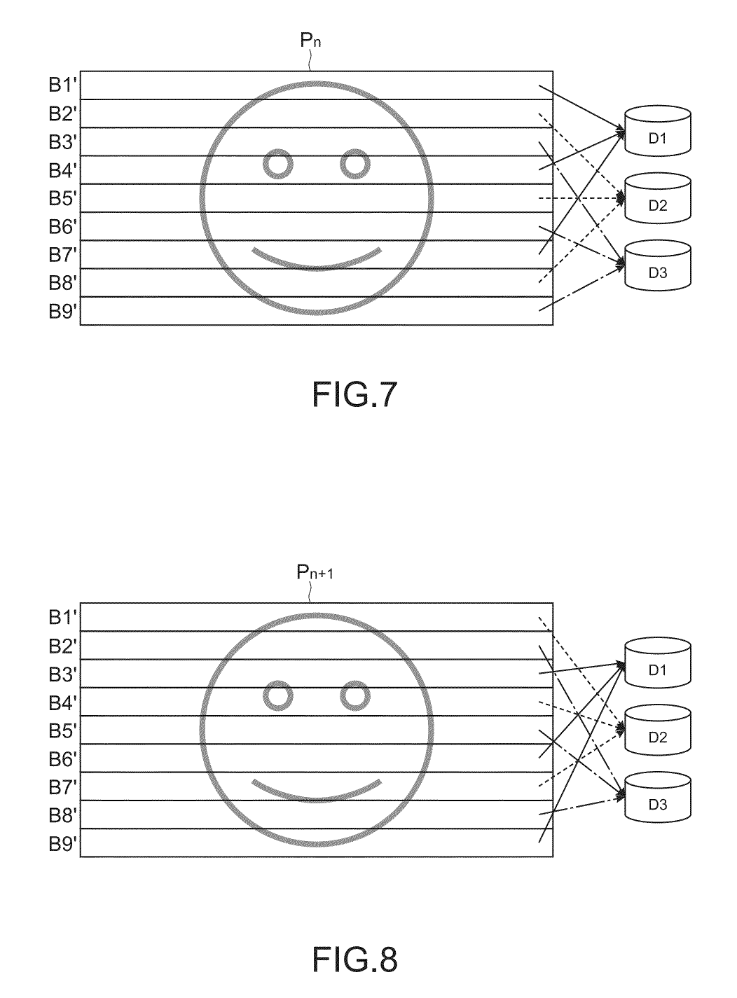

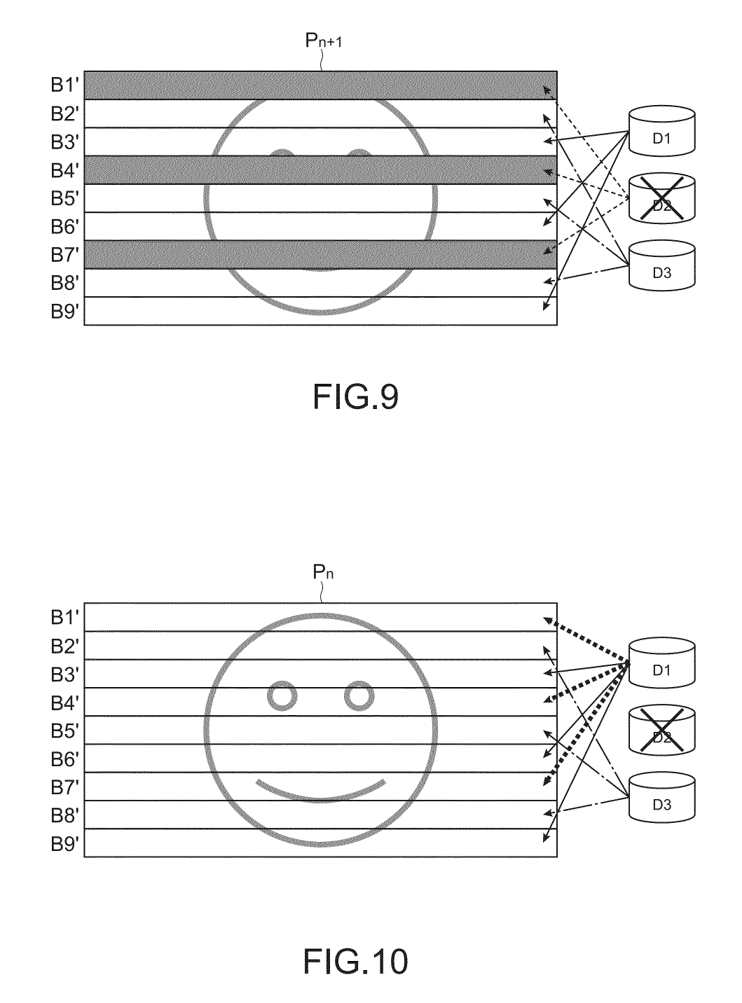

Described next is a specific example of the concealment process. FIG. 7 is a diagram schematically showing how the information accumulation section 130 accumulates a picture as encoding blocks. FIG. 8 is a diagram schematically showing how a picture next to the picture of FIG. 7 is accumulated as encoding blocks. FIG. 9 is a diagram schematically showing how, when a disk becomes faulty, a picture thereon becomes partially not available for reading. FIG. 10 is a diagram schematically showing how the information acquisition section 150 performs the concealment process in the case of FIG. 9.

As described above, when only a disk becomes faulty, the recovery process is performed using the parity blocks. For the sake of simplicity, assumed herein is a case of performing the picture-to-picture concealment process without performing the recovery process using the parity blocks.

As shown in FIGS. 7 and 8, the information accumulation section 130 stores the encoding blocks B1 to B12 in order onto the disks D1 to D3 as shown in FIGS. 4 and 5. These encoding blocks B1 to B12 are those respectively corresponding to the blocks B1′ to B12′ in two consecutive pictures Pₙ and Pₙ₊₁. As described above, the encoding blocks having the same position in the pictures Pₙ and Pₙ₊₁ are stored separately on different disks.

As shown in FIG. 9, when the disk D2 becomes faulty, for example, the encoding blocks stored thereon, i.e., the encoding blocks B1, B4, and B7 in the picture Pₙ₊₁, become not available for reading.

In this case, as shown in FIG. 10, these encoding blocks are concealed by other encoding blocks stored on the disk D1, i.e., the encoding blocks B1, B4, and B7 being at the corresponding positions in the picture Pₙ.

In video data, generally, there is a high correlation between images in any consecutive pictures, and there is also a high correlation between images on the lines having the same position in the pictures. Accordingly, when encoding blocks in a picture become not available for reading due to a disk failure, the information acquisition section 150 conceals these blocks by other encoding blocks having the same position in one picture before, thereby being able to output an image looking similar to the reading-not-available image. That is, compared to a case of using dummy data prepared in advance for a predetermined image for use to the concealment process, for example, the information acquisition section 150 may prevent any possible degradation of the image quality to be caused by the concealment process.

In this embodiment, the above-mentioned high-quality concealment process is implemented by the information accumulation section 130 storing encoding blocks adjacent to each other in a picture separately onto different disks, and storing encoding blocks having the same position in two consecutive pictures separately onto different disks.

Also in this embodiment, the encoding section 120 defines a plurality of lines in each picture as an encoding block. Because the video data is generally input on a line basis, data processing on the basis of a plurality of lines leads to a shorter processing delay compared to data processing on a picture basis.

Alternatively, when any of the disks is found faulty, the disk may be exchanged with a not-faulty vacant disk, and encoding blocks recovered or concealed by the remaining disk(s) may be reconstructed on the new disk.

### Second Embodiment

Described next is a second embodiment of the present technology. In this second embodiment, any differences from the first embodiment described above will be mainly described. Any details not referred to are the same as those described in the first embodiment.

In the first embodiment described above, the encoding blocks are each a plurality of lines. The encoding block is not restrictive to such a unit, and a plurality of pixels in the shape of a square or rectangle may configure an encoding block.

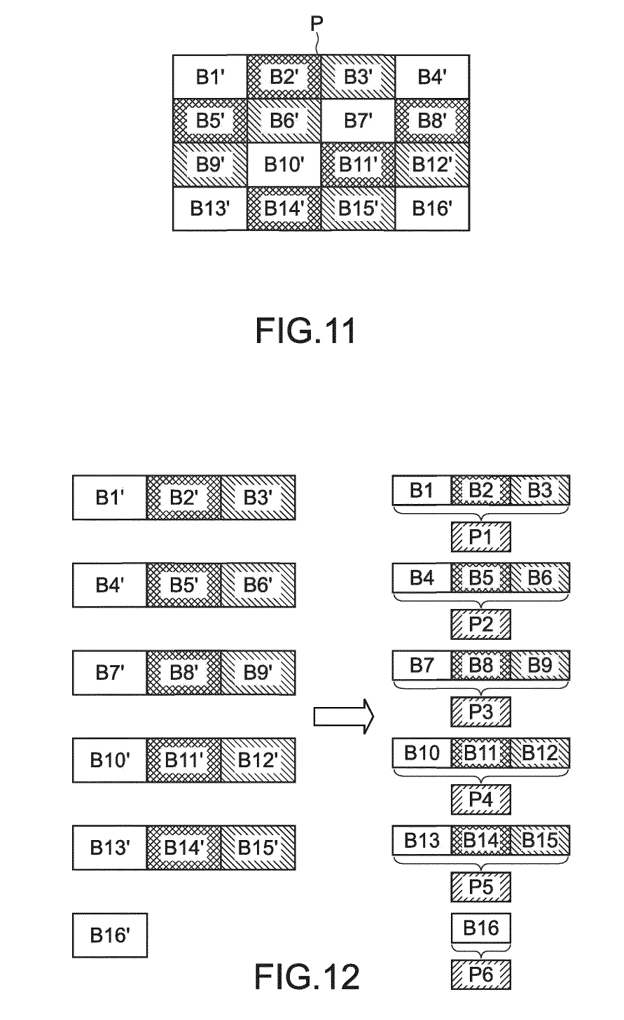

FIG. 11 is a diagram showing exemplary encoding blocks generated in the second embodiment. FIG. 12 is a diagram showing exemplary parity blocks generated in the second embodiment.

As shown in FIGS. 11 and 12, in the second embodiment, the encoding section 120 divides a picture into 16 rectangular pixel blocks B1′ to B16′, and based on these rectangular pixel blocks, generates encoding blocks B1 to B16, for example. At this time, the encoding section 120 provides the block Nos respectively to the headers of the encoding blocks B1 to B16. These block Nos are those corresponding to the ordinal numbers of the blocks in FIGS. 11 and 12.

The information accumulation section 130 then generates a parity block basically on the basis of three encoding blocks. That is, a parity block P1 is generated based on the encoding blocks B1 to B3, a parity block P2 is generated based on the encoding blocks B4 to B6, a parity block P3 is generated based on the encoding blocks B7 to B9, a parity block P4 is generated based on the encoding blocks B10 to B12, and a parity block P5 is generated based on the encoding blocks B13 to B15. Note here that a parity block P6 is generated only based on the last encoding block B16.

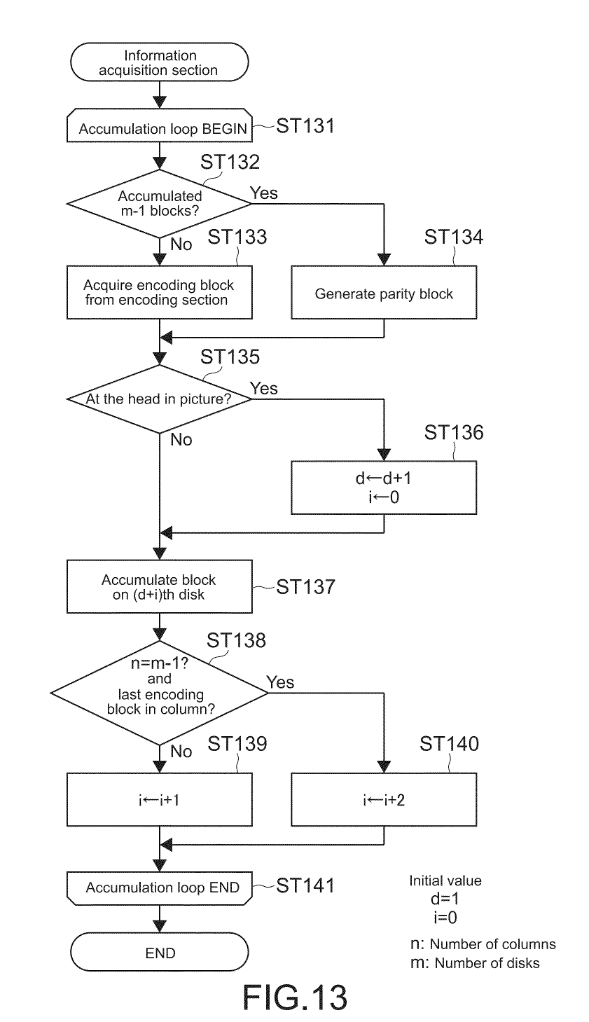

FIG. 13 is a flowchart showing the flow of a process of accumulating the encoding blocks and the parity blocks in the second embodiment. In the drawing, m denotes the number of disks, and n denotes the ordinal number of a column (in the vertical direction) including the encoding blocks in a picture. The left end column in each picture is a first column, and n in this case is 1.

As shown in FIG. 13, when receiving the encoding blocks from the encoding section 120, the information accumulation section 130 starts a loop process of accumulating the encoding blocks (steps 131 to 141).

In this loop process, the information accumulation section 130 determines whether or not the number of the encoding blocks accumulated as above reaches m−1 (step 132).

When determining that the number of the accumulated encoding blocks is not yet m−1 (No), the information accumulation section 130 acquires another encoding block from the encoding section 120 (step 133).

On the other hand, when determining that the number of the accumulated encoding blocks is m−1 (Yes), the information accumulation section 130 generates a parity block using the (m−1) pieces of blocks (step 134).

Next, as to the acquired encoding block, the information accumulation section 130 refers to the block No in the header thereof to determine whether or not the encoding block is at the head in the picture (step 135).

When determining that the encoding block is at the head in the picture (Yes), the information accumulation section 130 increments the value of a counter d, and initializes the value of a counter i (step 136). Herein, the initial value of the counter d is 1, and the initial value of the counter i is 0.

When determining that the encoding block is not at the head in the picture (No), and when the process of step 136 is done, the information accumulation section 130 issues a write command for the auxiliary storage control section 140 to accumulate the encoding block acquired as above onto the (d+i)th disk (step 137).

Next, the information accumulation section 130 determines whether or not the column ordinal number n is equal to m−1, and whether or not the encoding block stored immediately therebefore is the last one (at the bottom) of the column (step 138).

When determining that the column ordinal number n is not equal to m−1, or when determining that the acquired encoding block is not the last one of the column (No), the information accumulation section 130 increments once the value of the counter i (step 139).

On the other hand, when determining that the column ordinal number n is equal to m−1, and when determining that the stored encoding block is the last one of the column (Yes), the information accumulation section 130 increments twice the value of the counter i (step 140).

The procedure repeats these processes of steps 132 to 140 every time the information accumulation section 130 receives the encoding block from the encoding section 120. The encoding blocks and the parity blocks are then distributed to and stored on a plurality of disks via the auxiliary storage control section 140.

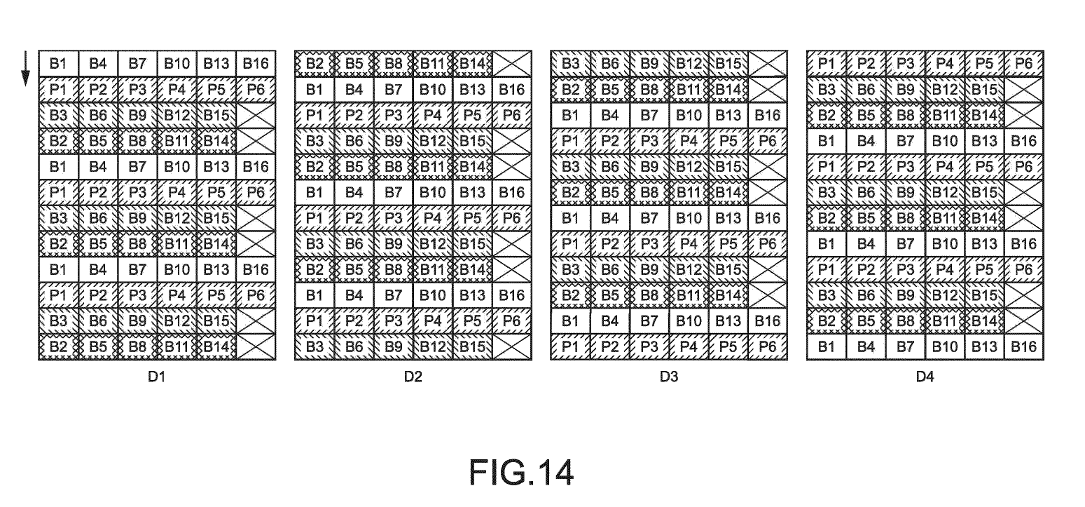

FIG. 14 is a diagram showing an exemplary distribution placement of the blocks stored on four disks D1 to D4 by the processes described above.

As shown in FIG. 14, similarly to the first embodiment described above, two encoding blocks having the same position in two consecutive pictures are stored separately on different disks.

Also similarly to the first embodiment, FIG. 14 shows that two encoding blocks adjacent to each other in a picture are stored separately on different disks. That is, in this second embodiment, unlike the first embodiment, the encoding blocks are each in the rectangular shape. Therefore, the encoding blocks may adjacent to each other both in the vertical and lateral directions. In consideration thereof, in the second embodiment, the information accumulation section 130 prevents any adjacent encoding adjacent blocks to be stored on the same disk by using the algorithm considering the positional relationship of the encoding blocks in all four directions, i.e., up, down, right, and left, as shown in FIG. 13 referred to in the above.

### Third Embodiment

Described next is a third embodiment of the present technology.

In the first and second embodiments described above, exemplified is the distributed storage of encoding blocks on a plurality of disks. However, the scope of the present technology is applicable not only to the process of storing the encoding blocks onto the disks but also to a process of transmitting the encoding blocks over a network.

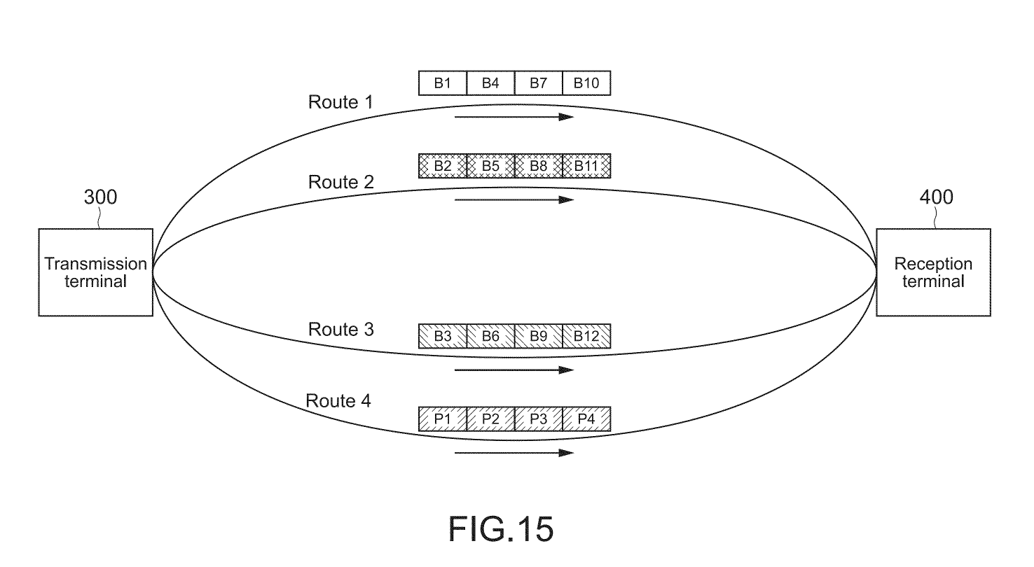

FIG. 15 is a diagram showing a network configuration and transmission routes for encoding blocks in the system of the third embodiment.

As shown in FIG. 15, in this embodiment, an encoding block generated in a transmission terminal 300 is transmitted to a reception terminal 400 via a plurality of (e.g., four) transmission media (routes and channels).

These transmission media may be a cable network including Ethernet (trademark) or may be a wireless network including wireless LAN and ad hoc network.

Similarly to the first embodiment, an encoding section of the transmission terminal 300 generates an encoding block for each of a plurality of lines (B1 to B12), and an information accumulation section of the transmission terminal 300 generates a parity block for every three encoding blocks (P1 to P4), for example. The information accumulation section then outputs the encoding blocks and the parity blocks onto a plurality of transmission media. Alternatively, the encoding block may be generated not only for a plurality of lines but also for a plurality of rectangular pixels, for example.

The algorithm for selecting a route or a channel for transmission of the encoding blocks and the parity blocks is similar to that of FIG. 4 referred to in the first embodiment. That is, the encoding blocks and the parity block in a picture are sequentially transmitted one by one from the d-th route to the (d+m−1) route. When the blocks in the picture are entirely transmitted, blocks in the next picture are then transmitted from the (d+i)th route.

The reception terminal 400 uses the encoding blocks received via the above-mentioned routes as a basis to reproduce video data. At this time, when any one of the routes becomes faulty, and when any (packet) of the encoding blocks for the route is lost, the reception terminal 400 uses the parity blocks provided via other routes to recover the lost encoding block. When two or more of the routes become faulty, the reception terminal 400 conceals the lost encoding block by another encoding block in a picture previous to the picture of the lost encoding block (the another encoding block being provided via other routes). The algorithm for this recovery and concealment processes is similar to that of FIG. 6 referred to in the first embodiment above.

Alternatively, when detecting that any of the routes becomes faulty, the reception terminal 400 may request the transmission terminal 300 to transmit the encoding blocks and the parity blocks over the other routes.

The transmission system in this embodiment is used for streaming distribution of live video data, for example.

Alternatively, the parity blocks may be transmitted over a highly-reliable route in the routes because of being important blocks for recovering any lost encoding blocks. Still alternatively, the parity blocks may not be generated or transmitted with the wireless network in an attempt to save the data capacity as much as possible. Also in this case, the lost encoding blocks are recovered almost fully by the concealment process described above.

### Modified Example

The present technology is in all aspects illustrative and not restrictive, and it is understood that numerous other modifications and variations may be devised without departing from the gist of the present technology.

In the first and third embodiments described above, the encoding block is generated for each of a plurality of lines, and in the second embodiment, is generated for each of a plurality of rectangular pixels. Alternatively, the encoding block may be generated for every arbitrary graphic region such as ellipse. Still alternatively, when a block is configured by a plurality of pixel regions, these pixel regions may be adjacent to one another in a picture, or may be away from one another therein. In the pixel region, the number of pixels and the shape thereof may be varied every time the encoding process is performed. The encoding blocks may be each defined by being subdivided in the color space like Y, Cb, and Cr. With the encoding block defined by subdivision as such, the concealment process is to be performed flexibly when an error occurs.

In the embodiments described above, in the concealment process at the time of disk failure, any encoding blocks failed to be read are concealed by other encoding blocks in a picture previous to the picture including the reading-not-available encoding blocks. Alternatively, the reading-not-available encoding blocks may be concealed not by other encoding blocks in the previous picture but by those in the next picture. In principle, the information acquisition section 150 performs the concealment process with a previous picture. Alternatively, when the concealment process is not performed properly with one and two pictures before, for example, the information acquisition section 150 may perform the concealment process with a next picture.

The components in the recording/reproduction apparatus 100 described in the first embodiment, i.e., the encoding section 120 and the information accumulation section 130, and the information accumulation section 130 and the auxiliary storage control section 140, may be connected together over a network. That is, the apparatus in charge of the encoding process may be provided separately from the apparatus in charge of the storage process onto a disk, and the encoding blocks transmitted over the network by the former apparatus may be distributed to and stored on a plurality of disks by the latter apparatus.

In the first and second embodiments described above, exemplified is a case of applying the present technology to the recording/reproduction apparatus. This is not restrictive, and the present technology is applicable to any type of information processing apparatus including smartphone, mobile phone, tablet PC (Personal Computer), desktop PC, notebook PC, TV, PDA (Personal Digital Assistant), mobile AV player, electronic book, digital still camera, camcorder, television receiver, game machine, projector, vehicle navigation system, and others.

### (Others)

The present technology is also in the following structures.

(1) An information processing apparatus, including:

an encoding section configured to be able to encode a plurality of pictures of video data on a block basis, the block being a part of each of the pictures; and

an output section configured to be able to distribute the encoded blocks to have two of the blocks outputted separately onto two of a plurality of media, the two of the blocks having the same position in two consecutive pictures of the pictures.

(2) The information processing apparatus according to (1), in which

the output section is able to output the blocks to have two of the blocks outputted separately onto two of the media, the two of the blocks being adjacent to each other in one of the pictures.

(3) The information processing apparatus according to (1) or (2), further including

a reproduction section configured to be able to reproduce, when at least one of the media becomes faulty, the video data by concealing the block at a first position in a first picture by the block at the first position in a second picture in the pictures, the first picture being found on the faulty medium, the second picture being closest in time to the first picture.

(4) The information processing apparatus according to any one of (1) to (3), in which

the encoding section is able to generate an error correction code for each of the blocks including the two blocks adjacent to each other,

the output section is able to output the blocks not to have the error correction code outputted onto any same one of the media as the block based on which the error correction code is generated, and

when at least one of the media becomes faulty, and when the block at the first position in the first picture is failed to be decoded by the error correction code, the reproduction section is able to conceal the block at the first position in the first picture by the block at the first position in the second picture.

(5) The information processing apparatus according to any one of (1) to (4), in which

the encoding section is able to encode at least one line in each of the pictures as the block.

(6) The information processing apparatus according to any one of (1) to (4), in which

the encoding section is able to encode at least one pixel region in a predetermined shape as the block, the pixel region being a part of each of the pictures.

(7) The information processing apparatus according to any one of (1) to (6), in which

the media includes a plurality of storage media, and

the output section is able to output the encoded blocks to be distributed to the storage media for storage.

(8) The information processing apparatus according to any one of (1) to (6), in which

the media includes a plurality of transmission media,

the output section is able to output the encoded blocks onto the transmission media to be received by a reception apparatus by being distributed and transmitted onto the transmission media, and

the reception apparatus is able to reproduce, when at least one of the transmission media becomes faulty, the video data by concealing the block at a first position in a first picture by the block at the first position in a second picture in the pictures, the first picture being transmitted onto the faulty medium, the second picture being transmitted to and received by the remaining transmission medium, the second picture being closest in time to the first picture.

The present disclosure contains subject matter related to that disclosed in Japanese Priority Patent Application JP 2012-186530 filed in the Japan Patent Office on Aug. 27, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
an encoding section configured to be able to encode a plurality of pictures of video data on a block basis, the block being a part of each of the pictures; and
an output section configured to be able to distribute the encoded blocks to have two of the blocks outputted separately onto two of a plurality of media, the two of the blocks having the same position in two consecutive pictures of the pictures.

2. The information processing apparatus according to claim 1, wherein
the output section is able to output the blocks to have two of the blocks outputted separately onto two of the media, the two of the blocks being adjacent to each other in one of the pictures.

3. The information processing apparatus according to claim 2, further comprising
a reproduction section configured to be able to reproduce, when at least one of the media becomes faulty, the video data by concealing the block at a first position in a first picture by the block at the first position in a second picture in the pictures, the first picture being found on the faulty medium, the second picture being closest in time to the first picture.

4. The information processing apparatus according to claim 3, wherein
the encoding section is able to generate an error correction code for each of the blocks including the two blocks adjacent to each other,
the output section is able to output the blocks not to have the error correction code outputted onto any same one of the media as the block based on which the error correction code is generated, and
when at least one of the media becomes faulty, and when the block at the first position in the first picture is failed to be decoded by the error correction code, the reproduction section is able to conceal the block at the first position in the first picture by the block at the first position in the second picture.

5. The information processing apparatus according to claim 2, wherein
the encoding section is able to encode at least one line in each of the pictures as the block.

6. The information processing apparatus according to claim 2, wherein
the encoding section is able to encode at least one pixel region in a predetermined shape as the block, the pixel region being a part of each of the pictures.

7. The information processing apparatus according to claim 3, wherein
the media includes a plurality of storage media, and
the output section is able to output the encoded blocks to be distributed to the storage media for storage.

8. The information processing apparatus according to claim 2, wherein
the media include a plurality of transmission media,
the output section is able to output the encoded blocks onto the transmission media to be received by a reception apparatus by being distributed and transmitted onto the transmission media, and
the reception apparatus is able to reproduce, when at least one of the transmission media becomes faulty, the video data by concealing the block at a first position in a first picture by the block at the first position in a second picture in the pictures, the first picture being transmitted onto the faulty medium, the second picture being transmitted to and received by the remaining transmission medium, the second picture being closest in time to the first picture.

9. An information processing method, comprising:
encoding a plurality of pictures of video data on a block basis, the block being a part of each of the pictures; and
distributing the encoded blocks to have two of the blocks outputted separately onto two of a plurality of media, the two of the blocks having the same position in two consecutive pictures of the pictures.

10. A program causing an information processing apparatus to execute:
encoding a plurality of pictures of video data on a block basis, the block being a part of each of the pictures; and
distributing the encoded blocks to have two of the blocks outputted separately onto two of a plurality of media, the two of the blocks having the same position in two consecutive pictures of the pictures.
